(19) United States
(12) Patent Application Publication
(10) Pub. No.: US 2025/0322243 A1
(43) Pub. Date: Oct. 16, 2025

(54) DECODING INVERTIBLE EMBEDDINGS FOR INSTRUCTION PROMPT OPTIMIZATION IN BLACKBOX LARGE LANGUAGE MODELS

(71) Applicant: INTUIT INC., Mountain View, CA (US)

(72) Inventors: Jiaxin ZHANG, Mountain View, CA (US); Wendi CUI, Mountain View, CA (US); Kamalika DAS, Mountain View, CA (US); Sricharan Kallur Palli KUMAR, Mountain View, CA (US)

(73) Assignee: INTUIT INC., Mountain View, CA (US)

(21) Appl. No.: 18/633,387

(22) Filed: Apr. 11, 2024

(51) Int. Cl. G06N 3/0895

(52) U.S. Cl. CPC G06N 3/0895

(57) ABSTRACT

A system and method for optimizing instructions for Large Language Models (LLMs). The system and method comprise a text embedding model configured to convert the text prompt into an embedding space. An optimization module is configured to optimize the prompt in the embedding space, and an invertible embedding model is configured to decode the optimized embedding space back into a text prompt that may be input to a blackbox LLM.

### BACKGROUND

Large Language Models (LLMs) have emerged as a powerful tool in the field of Natural Language Processing (NLP). These models are capable of understanding and following instructions in both zero-shot and few-shot scenarios. Zero-shot and few-shot scenarios refer to the ability of LLMs to follow instructions without any prior examples (zero-shot) or with a limited number of examples (few-shot) provided for learning. The process of providing instructions to these models, known as “prompt engineering,” often relies on expert human users and involves time-consuming and costly trial-and-error methods. Advanced LLMs function as black boxes, with their APIs provided, making it difficult to develop a gradient-based instruction optimization that requires back-propagation through these models.

Despite the advancements in LLMs, there are several challenges associated with their use. One of the primary challenges is the optimization of the instructions given to these models. The performance of LLMs is heavily influenced by the phrasing of the instructions given, and slight changes can lead to a decline in performance. Furthermore, instructions are made up of discrete words or sentences, making it challenging to optimize within a continuous space. This necessitates grappling with combinatorial optimization, which involves complex structural restrictions. Additionally, the process of “prompt engineering” often depends on the expert human user's experience in crafting instructions through time-consuming and costly trial-and-error methods. Therefore, finding ways to automate the search or optimization of instructions for any given task remains a substantial challenge in the field.

### SUMMARY

Embodiments disclosed herein solve the aforementioned technical problems and may provide other technical solutions as well. Contrary to conventional techniques, the disclosed solution includes a novel method of instruction optimization that focuses on optimizing a soft prompt, i.e., text embeddings, using gradient-free methods, and decoding the optimized soft prompt back to discrete text using invertible embedding models. The disclosed solution further enhances efficiency by reducing the dimension of the embedding space to a low-dimensional manifold, a novel approach that makes Bayesian Optimization feasible to achieve high performance more efficiently.

An example embodiment includes a system for optimizing instructions for LLMs, comprising a text embedding model configured to receive a discrete text prompt from a user device, and encode the discrete text prompt into a high-dimensional embedding space, creating a high-dimensional soft text prompt, a dimension reduction module configured to transform the high-dimensional soft text prompt to a lower-dimensional embedding space, creating a low-dimensional soft text prompt, an optimization module configured to optimize the lower-dimensional soft text prompt, and an invertible embedding model configured to decode the optimized lower-dimensional soft text prompt into an output text prompt, which is configured to be input to a blackbox LLM via API calls.

Another example embodiment includes a method of optimizing instructions for LLMs, comprising receiving a discrete text prompt from a user device, encoding, by a text embedding model, the discrete text prompt into a high-dimensional embedding space, creating a high-dimensional soft text prompt, transforming, by a dimension reduction module, the high-dimensional soft text prompt to a lower-dimensional embedding space, creating a low-dimensional soft text prompt, optimizing, by an optimization module, the lower-dimensional soft text prompt, and decoding, by an invertible embedding model, the optimized lower-dimensional soft text prompt into a output text prompt, which is configured to be input to blackbox LLM via API calls.

### BRIEF DESCRIPTION OF THE DRAWINGS

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 illustrates an optimization system, according to aspects of the present disclosure.

FIG. 2 depicts a process for optimizing text prompts, according to aspects of the present disclosure.

FIG. 3 shows a process for training an invertible embedding model, according to aspects of the present disclosure.

FIG. 4 presents a process for Bayesian Optimization in the context of optimizing text prompts, according to aspects of the present disclosure.

FIG. 5 depicts a block diagram of an example computing system of the devices in FIG. 1, according to aspects of the present disclosure.

### DETAILED DESCRIPTION OF SEVERAL EMBODIMENTS

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatuses as known by one of ordinary skill in the relevant art may not be discussed in detail but are intended to be part of the specification where appropriate. In the examples illustrated and discussed herein, any specific values should be interpreted to be illustrative and non-limiting. Thus, other example embodiments may have different values. It is noted that similar reference numerals and letters refer to similar items in the figures, and once an item is defined for one figure, it is possible that it need not be further discussed for the other figures.

The present disclosure relates to the field of NLP, and more particularly, to a system and method for optimizing instructions given to LLMs. LLMs have shown exceptional ability to follow instructions in both zero-shot and few-shot scenarios. However, their performance can be heavily influenced by the phrasing of the instructions given, and slight changes can lead to a decline in performance. As noted above, the “prompt engineering” process of providing instructions typically relies on expert human users and involves time-consuming and costly trial-and-error methods.

The disclosed system and method address this challenge by optimizing a soft prompt, i.e., text embeddings, via gradient-free methods, and leveraging invertible embedding models to decode the optimized soft prompt to discrete text. This text can be used for blackbox LLM via API calls. The soft prompt optimization is formulated as a form of latent space Bayesian Optimization (BO), which takes each soft prompt and the corresponding zero-shot performance as an input-output pair of the optimization objective. To achieve an efficient optimization process, the dimension of the embedding space is reduced to a low-dimensional manifold, making BO feasible to achieve high performance more efficiently.

By optimizing the soft prompt, the performance of the LLM in following given instructions can be improved. This can lead to more accurate and efficient results, reducing the time and cost associated with trial-and-error methods. Furthermore, by leveraging invertible embedding models, the optimized soft prompt can be decoded back into a discrete text instruction that can be used as an input to blackbox LLMs via API calls. This allows for the optimization of instructions even for advanced LLMs that function as black boxes.

In the context of blackbox LLMs, an API call may serve as a conduit for communication between the optimization system and the LLM. It may be a predefined protocol that allows the system to send optimized instruction prompts to the LLM and receive the LLM's responses. The API abstracts the internal workings of the LLM, providing a set of accessible endpoints for submitting prompts and retrieving results. This enables the system to interact with the LLM without needing to understand or access its complex underlying architecture. By using API calls, the system can leverage the LLM's advanced processing capabilities to perform tasks in NLP, while the LLM remains a ‘black box’, with its internal processes remaining opaque and inaccessible to the system. This interaction is pivotal for the disclosed method, as it allows for the seamless integration of optimized prompts into the LLM's workflow, thereby enhancing its performance in various NLP tasks. LLMs that utilize API calls may include but are not limited to GPT from OpenAI, Claude from Anthropic, Bard/Palm from Google, etc.

For instance, consider a scenario where an LLM is tasked with providing tax advice. The initial instruction or ‘hard prompt’ given to the LLM might be “How do I tax?”. This hard prompt is then encoded into a high-dimensional embedding space using a text embedding model, creating the ‘soft prompt’. The soft prompt is optimized in the embedding space using a gradient-free method, for example, latent space BO. Once the soft prompt is optimized, it is decoded back into a discrete text instruction or ‘hard prompt’ using an invertible embedding model. This optimized hard prompt may be a more precise and informative prompt such as “Please provide guidance on calculating personal income tax for a freelance worker in the United States” which can then be used as an input to blackbox LLMs via API calls, potentially improving the clarity and relevance of the LLM's response to the user's tax inquiry.

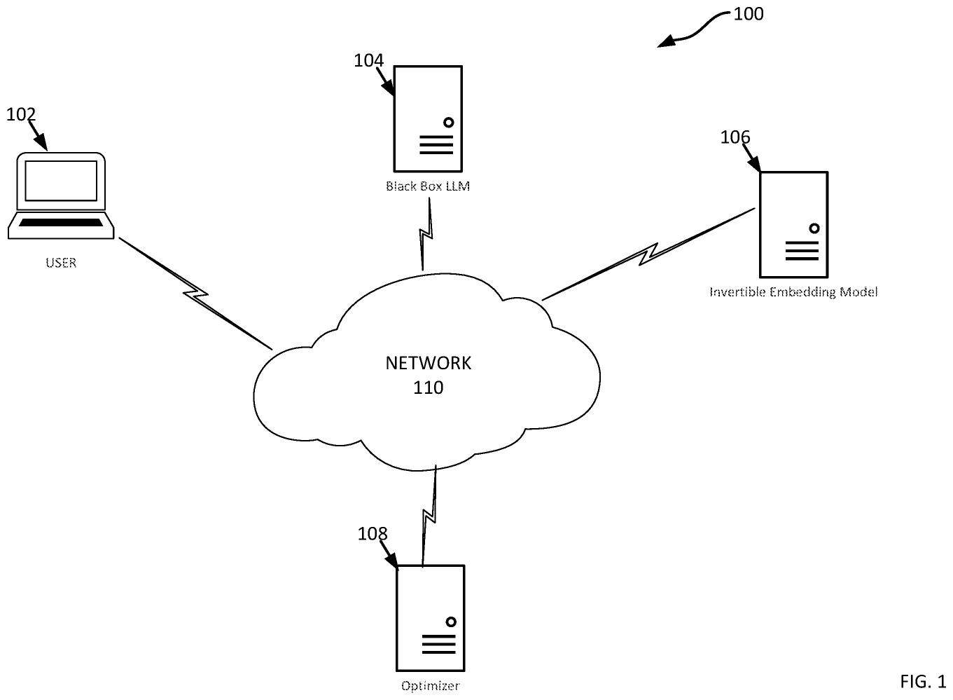

Referring to FIG. 1, an optimization system 100 is depicted. The system 100 may include a user device 102, a blackbox LLM server 104, an invertible embedding model server 106, and a prompt optimizer server 108, all interconnected via a communication network 110. In some scenarios, the user device 102 serves as the point of input for user prompts. These prompts are then processed by the prompt optimizer server 108 and the invertible embedding model server 106 to generate optimized prompts. The optimized prompts are then input to the blackbox LLM server 104.

For example, the devices in FIG. 1 may collaborate to streamline the process of providing optimized tax advice through an LLM. A user, perhaps a tax professional or an individual seeking tax guidance, inputs a query into the user device 102, such as “What deductions am I eligible for as a self-employed individual?” This query, which may initially be vague or suboptimal for the LLM to process effectively, is transmitted via the communication network 110 to the prompt optimizer server 108. The prompt optimizer server 108, utilizing advanced algorithms, refines the user's query into a more precise and effective prompt. It does so by encoding the query into a high-dimensional soft text prompt using a text embedding model. This soft prompt is distilled into a lower-dimensional representation that retains the core information but is more manageable for optimization purposes. The optimization module within the prompt optimizer server 108 employs techniques such as BO to fine-tune the soft prompt without the gradient information that is inaccessible due to the black box nature of the LLM. Once the soft prompt is optimized, it is sent to the invertible embedding model server 106. Here, the optimized soft prompt is decoded back into a discrete, human-readable text prompt. This newly optimized prompt is designed to elicit a more accurate and comprehensive response from the LLM when querying about tax deductions. The blackbox LLM server 104 receives the optimized prompt via API calls. The LLM, which has been trained on vast amounts of tax-related data, processes the prompt and generates a detailed and tailored response. This response might include a list of potential deductions, specific forms to be filled, and guidance on how to apply for each deduction, thereby providing the user with actionable tax advice. The collaboration of these devices ensures that the user receives precise and valuable tax information, minimizing the ambiguity and inefficiency that often accompany complex tax inquiries.

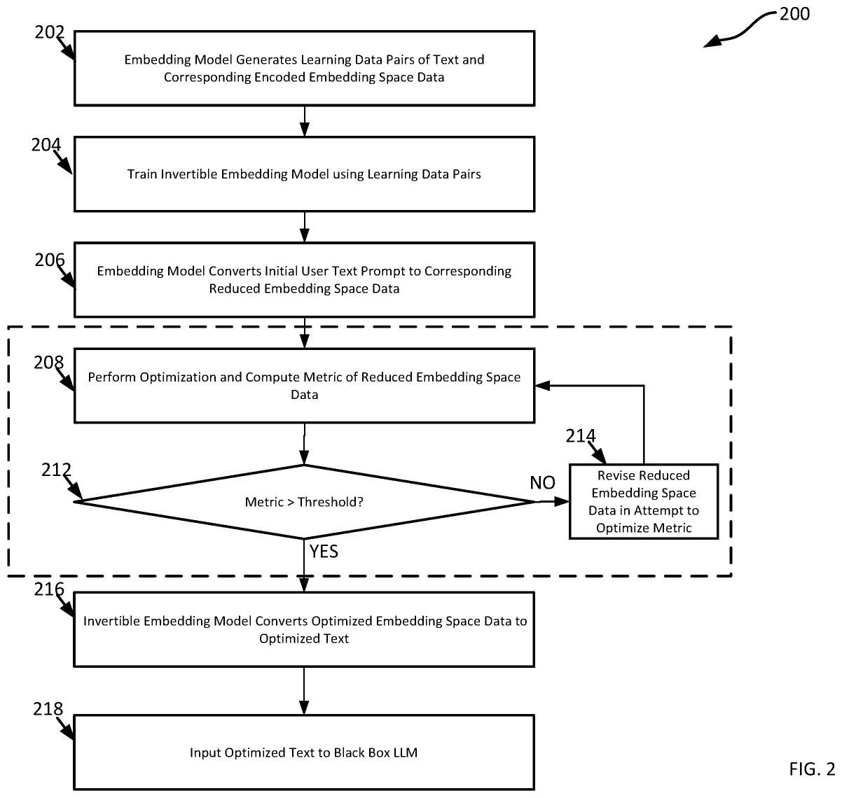

Referring now to FIG. 2, a process 200 is depicted which outlines the steps for optimizing text prompts for use with LLMs in accordance with an example embodiment. The process 200 begins with a learning data generation step 202. In some aspects, an embedding model may generate learning data pairs of text and corresponding encoded embedding space data. For instance, a pre-trained text embedding model may be used for encoding the discrete prompt into the embedding space.

Following this, the process 200 continues at an invertible model training step 204. In some cases, the invertible embedding model may be trained using the learning data pairs of text and corresponding embedding space data which may be numerical representations of text within a high-dimensional vector space, where similar meanings are encoded by proximate vectors.

A text prompt to embedding conversion step 206 may occur next, where the embedding model may convert the initial user text prompt to corresponding reduced embedding space data. In some aspects, a dimension reduction module may transform the high-dimensional soft text prompt into a lower-dimensional embedding space using uniform projection.

The transformation of the high-dimensional soft text prompt into a lower-dimensional embedding space may be achieved by projecting the high-dimensional vectors, which represent the encoded text prompts, onto a lower-dimensional manifold (low-dimensional vector). A dimension reduction module may employ mathematical techniques to reduce the number of dimensions while preserving the salient features of the data. This is analogous to compressing data into a more compact form without losing its essence. In other words, vectors in high-dimensional space often contain a lot of redundant information, and not all dimensions are equally informative for the task at hand. By reducing the dimensionality, the optimization module can decrease computational complexity and focus on the core features that are more relevant for the performance of the LLM. This is done by identifying a subspace that captures the majority of the variance in the data or by finding a new representation that maintains the distances between points, known as embeddings, in the high-dimensional space. The lower-dimensional space is designed to be a smooth, continuous manifold, which allows for gradient-free optimization methods to navigate the space more efficiently. This is because in a lower-dimensional space, the search for the optimum soft prompt is less computationally intensive, and the relationships between different prompts are easier to model. The reduced dimensionality also helps in avoiding the curse of dimensionality, which can hamper the optimization process in high-dimensional spaces due to the exponential increase in volume associated with adding extra dimensions.

It is noted that the vectors mentioned in the disclosure are machine-interpretable representations that serve as a bridge between human-readable text and the numerical processing capabilities of computer systems. In the context of NLP and LLMs, vectors are high-dimensional arrays of numerical values that encode the semantic and syntactic properties of text prompts. Each dimension within a vector corresponds to a specific feature or attribute derived from the text, allowing the machine to capture the nuances of language in a form that can be efficiently processed. These vectors are generated through sophisticated models that analyze the text and translate it into a mathematical form, effectively converting words and sentences into a language that machines can ‘understand’. By representing text as vectors, we enable algorithms to perform operations such as similarity comparison, clustering, and optimization, which are integral to the functioning of LLMs and the optimization of text prompts. This machine-interpretable format is pivotal for the system disclosed herein, as it allows for the manipulation of text prompts within the embedding space, leading to the optimization of instructions for enhanced LLM performance.

The process 200 continues with an optimization and metric computation step 208. In some cases, optimization may be performed, and a metric of the reduced embedding space data may be computed. Examples of metrics that can be computed include accuracy, precision, recall, F1 score, and cosine similarity.

A decision is made at a metric threshold decision point step 212, determining if the metric exceeds a predefined threshold. If the metric does not meet the threshold (a NO at step 212), the process 200 may continue at an embedding space revision step 214 before looping back to the optimization and metric computation step 208. In some aspects, the reduced embedding space data may be revised in an attempt to optimize the metric. This revision may involve various strategies, such as adjusting the parameters of the dimension reduction module to better capture the nuances of the text prompt's meaning within the lower-dimensional space. Additionally, the optimization module may employ search algorithms to explore the embedding space, identifying regions that correlate with higher performance metrics. Techniques such as simulated annealing, genetic algorithms, or gradient-free local search could be utilized to iteratively refine the soft prompt. Furthermore, the optimization process may incorporate feedback loops, where the performance of the LLM with the current soft prompt informs subsequent revisions, creating a dynamic and responsive optimization cycle. In either case, once the metric meets or exceeds the threshold (a YES at step 212), the invertible embedding model may convert the optimized embedding space data to optimized text at an embedding to text conversion step 216, which decodes the optimized lower-dimensional soft text prompt back into a discrete text instruction that is input in step 218 to a blackbox LLM.

In some aspects, a performance evaluation model may evaluate the performance of the output text prompt using predefined testing data, including ground truth. The performance evaluation module may calculate performance metrics as the output given the soft text prompt, with the performance metrics used to evaluate the performance of the optimized instruction prompt. In some cases, the performance evaluation model may utilize at least one of an F1 score or an Area Under Receiver Operating Characteristic Curve (AUROC) as the performance metrics.

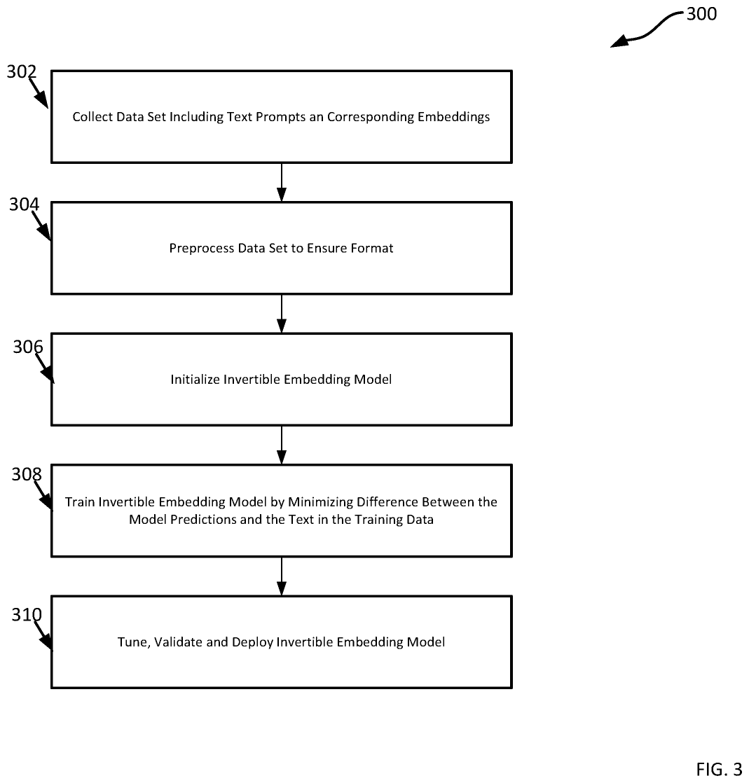

Referring now to FIG. 3, a process 300 is depicted which outlines the steps for training an invertible embedding model in accordance with an example embodiment. The process 300 begins with a data collection step 302. In some aspects, this step may involve gathering a dataset that includes text prompts and their corresponding embeddings. For instance, a dataset may be collected that includes a variety of text prompts and their corresponding embeddings generated by a pre-trained text to embedding model.

Following this, the process continues at a data preprocessing step 304. In some cases, this step ensures the dataset is in the correct format for model training. For example, the dataset may be preprocessed to ensure that the text prompts and their corresponding embeddings are properly paired and formatted for input into the invertible embedding model. The preprocessing of the dataset in the data preprocessing step 304 may involve several tasks to ensure that the data is suitable for training the invertible embedding model. Examples of preprocessing tasks include but are not limited to Tokenization: Breaking down the text prompts into individual words or tokens. This step is often the first in preparing text for embedding models, as it converts the raw text into a format that can be easily analyzed and processed by the model; Lowercasing: Converting the text in the prompts to lowercase to ensure that the model does not treat the same words in different cases as different tokens (e.g., “Tax” and “tax” are considered the same); Removing Stop Words: Stop words such as “the”, “is”, “in”, which are common and do not carry much meaning, may be removed to reduce the dimensionality of the data and focus the model on more meaningful words; Stemming/Lemmatization: Reducing words to their root form. For example, “running”, “runs”, “ran” are all variations of the word “run”. Stemming might reduce these to “run”, making the model's task simpler. Handling Missing Data: If there are any missing values in the dataset, these may be filled in, or the corresponding entries may be removed, depending on the chosen strategy; Noise Removal: This includes the elimination of irrelevant characters, such as special characters and numbers, that might not be useful for the model's training; Vectorization: Converting text to numerical form, such as word embeddings, so that it can be processed by machine learning algorithms. This may involve using pre-trained embeddings or creating embeddings as part of the model training; Padding/Truncation: Ensuring that text prompts are of a uniform length by either truncating them if they are too long or padding them with a special token if they are too short; Encoding Categorical Data: If there are categorical variables associated with the text prompts, these may be encoded into a numerical format that the model can understand, using techniques such as one-hot encoding; Data Augmentation: Generating new training samples from the existing data, for example, by paraphrasing the text prompts or using synonyms to replace some words, to increase the diversity and amount of the training data; Sequence Alignment: In cases where the text prompts are part of a sequence, ensuring that the sequences are aligned in a meaningful way for the model to learn from them.

A model initialization step 306 involves setting up the invertible embedding model with initial parameters. In some aspects, the invertible embedding model may be initialized with parameters that are optimized for the specific task of decoding optimized lower-dimensional soft text prompts back into discrete text instructions. The initial parameters for the invertible embedding model may include, but are not limited to: Learning Rate: The step size at each iteration while moving toward a minimum of a loss function; Batch Size: The number of training examples utilized in one iteration; Number of Layers: The number of layers in the neural network architecture of the invertible embedding model; Activation Function: The function used to introduce non-linearity into the output of a neuron, such as ReLU, sigmoid, or tanh; Weight Initialization: The method used to initialize the weights of the neural network, which could be random initialization, Xavier/Glorot initialization, or He initialization to name a few; Regularization Parameter: The coefficient for regularization terms to prevent overfitting, such as L1 or L2 regularization; Dropout Rate: The probability of dropping out neurons during training to prevent overfitting; Optimizer: The optimization algorithm used to minimize the loss function, such as Adam, SGD, or RMSprop; Loss Function: The function that measures the difference between the predicted output and the actual output, such as cross-entropy or mean squared error; Early Stopping Criteria: The conditions under which training is stopped before the maximum number of epochs is reached, often based on validation loss improvement.

The process 300 continues at a model training step 308 that trains the invertible embedding model by minimizing the difference between the model's predictions and the actual text in the training data. In some cases, the invertible embedding model may be trained using a variety of machine learning techniques, such as supervised learning, unsupervised learning, or reinforcement learning, to minimize the difference between the model's predictions and the actual text in the training data. During the model training step 308, the invertible embedding model may be trained through a supervised learning approach. For example, the model could utilize a sequence-to-sequence architecture with an encoder-decoder framework. The encoder part of the model takes the text prompts as input and generates a high-dimensional embedding. The decoder then attempts to reconstruct the original text prompt from this embedding. The objective may be to minimize the reconstruction loss, which is the difference between the original text prompt and the reconstructed text prompt from the embedding. To train the model, a large corpus of text prompts is fed into the encoder, which encodes the text into embeddings. These embeddings are then passed to the decoder, which outputs the reconstructed text prompts. The model's parameters are adjusted using backpropagation and an optimization algorithm, such as Adam or stochastic gradient descent, to minimize the reconstruction loss over several training iterations or epochs. The reconstruction loss could be measured using a loss function appropriate for the data, such as cross-entropy loss for categorical data or mean squared error for continuous data. Additionally, to improve the model's ability to generate accurate reconstructions, techniques such as teacher forcing, attention mechanisms, or scheduled sampling may be employed during training. Once the model achieves a low reconstruction loss on a validation set, indicating that it can accurately reconstruct text prompts from their embeddings, the training is concluded, and the model is considered ready for deployment in the optimization process.

The process 300 continues at a model tuning and deployment step 310 that involves fine-tuning the model, validating its performance, and preparing it for deployment. In some aspects, the invertible embedding model may be fine-tuned using a variety of techniques, such as hyperparameter tuning or transfer learning, to improve its performance. The model's performance may be validated using a variety of metrics, such as accuracy, precision, recall, or F1 score. Once the model's performance has been validated, it may be prepared for deployment, for instance, by packaging the model into a format that can be easily deployed on a variety of platforms.

In FIG. 3, each step in the process 300 is illustrated as being sequentially performed, indicating the progression from data collection to the deployment of the trained model. However, in some cases, the steps may be performed in a different order, or some steps may be omitted or added, depending on the specific requirements of the task at hand. For instance, additional steps may be added to the process to handle specific challenges associated with training invertible embedding models, such as handling overfitting or underfitting, or dealing with class imbalance in the training data.

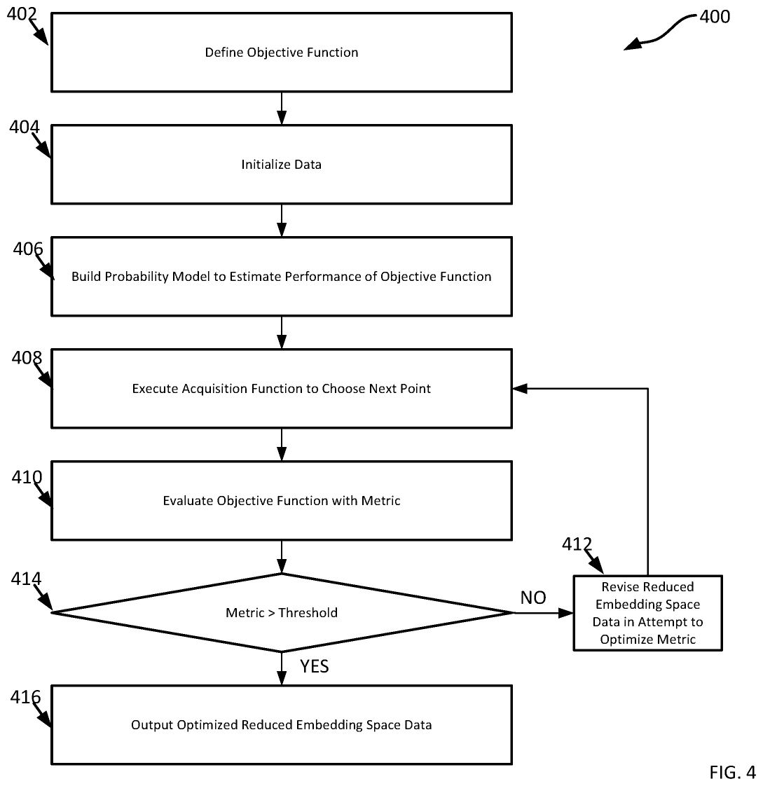

Referring now to FIG. 4, a process 400 is depicted which outlines the steps for BO in the context of optimizing text prompts for LLMs in accordance with an example embodiment. The process 300 begins with an objective function definition step 402. In some aspects, the objective function may be defined as the performance of the LLM in response to a given soft prompt. The performance may be measured using a variety of metrics, such as accuracy, precision, recall, or F1 score, depending on the specific task at hand.

The process 400 continues at a data initialization step 404. In some cases, the data may be initialized using a mix of LLM initialization and human handy-craft initialization. This may provide a diverse set of initial soft prompts for the optimization. For instance, the LLM initialization may involve prompting the LLM to come up with instruction prompts given several input-output examples, while the human handy-craft initialization may involve designing some initial instruction prompts from human experts.

LLM initialization involves leveraging the capabilities of the LLM to generate initial soft prompts based on a set of input-output examples. This process can be automated and scaled, allowing for the generation of a wide variety of prompts that can serve as starting points for optimization. Examples of LLM initialization include but are not limited to: Input-Output Pair Generation: Providing the LLM with a series of input-output pairs that exemplify the desired task, such as question-answer pairs for a Q&A system, and asking the LLM to generate corresponding instruction prompts; Paraphrasing: Feeding the LLM with a set of well-performing prompts and asking it to paraphrase these prompts into multiple variations, thus expanding the initial set of prompts for optimization; Expansion of Instructions: Giving the LLM a basic instruction and asking it to elaborate or expand upon it to create more detailed and varied prompts; Diverse Prompt Sampling: Using the LLM to generate prompts by sampling from different styles, tones, or complexity levels to ensure a broad range of initial prompts.

Handy-craft initialization involves the manual creation of initial soft prompts by human experts. This approach benefits from the nuanced understanding and creativity of experienced users who can craft prompts that are tailored to specific tasks or domains. Examples of handy-craft initialization include but are not limited to: Expert-Crafted Prompts: Domain experts create a set of instruction prompts based on their knowledge and experience with the task at hand, ensuring that the prompts are relevant and precise; Iterative Refinement: Starting with a basic prompt, human experts iteratively refine and adjust the language and structure of the prompt to improve its effectiveness; A/B Testing: Human experts design a small set of varied prompts and conduct A/B testing to determine which prompts yield better responses from the LLM, using the results to inform further prompt development; Competitive Analysis: Analyzing prompts used by similar systems or services and manually crafting new prompts that incorporate successful elements observed in the competitive landscape.

By combining LLM initialization with human handy-craft initialization, the system benefits from both the efficiency and diversity of machine-generated prompts and the insightful, targeted prompts created by human experts. This hybrid approach provides a rich and varied set of initial soft prompts for subsequent optimization processes.

The process 400 continues at a probability model building step 406 to estimate the performance of the objective function. In some aspects, the probability model may be built using a variety of techniques, such as Gaussian processes or other types of probabilistic models, to estimate the performance of the objective function given the current soft prompt.

In the context of the probability model building step 406, several types of probability models can be utilized to estimate the performance of the objective function. Examples of such probability models include but are not limited to: Gaussian Processes (GPs): Gaussian Processes are a type of non-parametric model that can predict the probability distribution of possible outcomes. They are particularly useful for modeling functions that are smooth and continuous, making them a popular choice for Bayesian Optimization; Bayesian Neural Networks (BNNs): BNNs incorporate Bayesian inference into neural networks, allowing for the estimation of uncertainty in the model's predictions. They are capable of learning complex patterns and can provide a probabilistic measure of the model's confidence in its predictions; Markov Chain Monte Carlo (MCMC) Methods: MCMC methods are used for sampling from probability distributions when direct sampling is challenging. They can be used to approximate the posterior distribution of model parameters, providing insights into the expected performance and uncertainty of the objective function; Probabilistic Matrix Factorization (PMF): PMF is a technique that decomposes a matrix into factors that represent latent variables. It is often used in recommendation systems and can be applied to optimize embeddings by capturing the underlying structure in the data; Dirichlet Processes: Dirichlet Processes are a family of stochastic processes used in Bayesian non-parametric models. They are useful for clustering and can be applied to group similar prompts together, aiding in the optimization process; Beta-Bernoulli Processes: These processes are used for modeling binary outcomes and can be applied to scenarios where the objective function is to optimize a binary metric, such as success or failure of a prompt; Hidden Markov Models (HMMs): HMMs are statistical models that assume an underlying Markov process with unobserved (hidden) states. They can be used to model sequential data and may be applied to optimize prompts that are part of a sequence; Conditional Random Fields (CRFs): CRFs are a class of statistical modeling methods often used in pattern recognition and are particularly suited for making predictions in cases where context is relevant, such as in the optimization of text prompts. Each of these probability models offers a different approach to estimating the performance of the objective function and can be chosen based on the specific characteristics of the optimization problem at hand.

An acquisition function is executed in step 408 to choose the next point for evaluation. In some cases, the acquisition function may be designed to balance exploration and exploitation, choosing points that are expected to improve the performance of the objective function while also exploring the search space to avoid getting stuck in local optima. Exploration refers to the process of searching through the optimization space to discover new, potentially better solutions that have not been evaluated before. Exploitation, on the other hand, focuses on utilizing the current knowledge to refine and improve upon known solutions that have already shown promise.

Examples of how the acquisition function may work to achieve the objective include but are not limited to: Expected Improvement (EI): The acquisition function calculates the expected improvement over the current known maximum. It selects the next point to evaluate by estimating where the greatest improvement is likely, based on the current model's predictions and uncertainty; Probability of Improvement (PI): This function measures the probability that a given point will result in an improvement over the current maximum. It tends to be more exploitative, focusing on areas with a higher likelihood of improvement; Upper Confidence Bound (UCB): The UCB function balances exploration and exploitation by considering both the prediction of the objective function and the uncertainty of the prediction. It selects points where the upper confidence bound of the predicted performance is high; Thompson Sampling: This method samples from the probability model to select the next point for evaluation. It is a stochastic method that can encourage exploration by considering a variety of potential outcomes; Entropy Search: The acquisition function aims to select a point that is expected to reduce the entropy of the posterior distribution the most, effectively reducing uncertainty about the location of the objective function's maximum; Knowledge Gradient: This function looks at the expected increase in the objective function value, given all the information available, including the potential information gain from evaluating a new point; Bayesian Optimization with Hyperband (BOHB): Combining Bayesian Optimization with Hyperband, this acquisition function efficiently balances exploration and exploitation by dynamically allocating resources to more promising configurations.

Each of these acquisition functions has its own strengths and is chosen based on the specific characteristics of the optimization problem, such as the dimensionality of the space, the computational budget, and the desired balance between exploring new areas and exploiting known good ones.

The objective function is evaluated with a metric in step 410. In some aspects, the performance of the current instruction prompt may be evaluated using predefined testing data, including ground truth. The testing data may be used to calculate performance metrics as the output given the current instruction prompt. For example, binary QA classification may use F1 or AUROC as the output score metric to evaluate the performance.

A decision point step 414 assesses whether the metric exceeds a predefined threshold. If the metric does not meet the threshold (a NO at step 414), the process 400 may continue at a reduced embedding space revision step 412 before looping back to step 408. In some cases, the reduced embedding space data may be revised in an attempt to optimize the metric. This may involve adjusting the soft prompt in the embedding space, for instance, by moving it in the direction that is expected to improve the performance of the objective function.

In some embodiments, revising the reduced embedding space to optimize the metric may involve various strategies such as applying perturbations to the current soft prompt representation, employing dimensionality expansion techniques to explore adjacent regions of the embedding space, or utilizing evolutionary algorithms to generate a population of candidate prompts that evolve over time. Additionally, gradient-free optimization techniques like simulated annealing or particle swarm optimization could be used to navigate the reduced embedding space, systematically adjusting the soft prompt to seek out areas correlated with higher performance metrics. Reinforcement learning approaches may also be employed, where an agent iteratively adjusts the soft prompt based on rewards received for improved performance outcomes. These revisions aim to fine-tune the soft prompt in a manner that aligns with the objective function's performance criteria, ultimately leading to the generation of an optimized text prompt that enhances the efficacy of the LLM's task execution.

Once the metric meets or exceeds the threshold (a YES at step 414), the optimized reduced embedding space data is outputted in step 416. The optimized reduced embedding space data is then decoded back into a discrete text instruction using an invertible embedding model. This optimized instruction can then be used as input to blackbox LLMs via API calls, potentially improving the performance of the LLM in the given task.

While the process 400 has been described with reference to specific steps and variations, it is to be understood that the process could be implemented with different steps or variations without departing from the scope of the process. For instance, different types of objective functions, data initialization methods, probability models, acquisition functions, evaluation metrics, or embedding space revision methods could be used. Furthermore, the process could be applied to different types of LLMs or tasks, and the specific details of the process could be adjusted based on the requirements of the specific task at hand.

The modules and processes describe with respect to FIGS. 2, 3, and 4 represent software components that are executed by one or more of the devices illustrated in FIG. 1. These devices, which include the user device 102, the blackbox LLM server 104, the invertible embedding model server 106, and the prompt optimizer server 108, are equipped with the requisite computational resources to run the software modules. The software orchestrates the transformation of discrete text prompts received from a user into optimized instructions through a series of encoding, optimization, and decoding steps. The optimized instructions may then be input to the blackbox LLM to achieve a desired result. Each module is designed to perform a specific function within the overall system, working in concert to refine prompts for LLMs. The execution of these software modules is facilitated by the interconnected nature of the devices, allowing for seamless data exchange and processing across the optimization system overview 100.

It is noted that the system/method disclosed herein acts as an intermediary, adeptly bridging the gap between the user's initial input and the sophisticated processing capabilities of blackbox LLM. At the outset, the user device 102 captures the discrete text prompt as input by the user, which may be a rudimentary or unrefined query. This prompt is then transmitted to the prompt optimizer server 108, which may execute the optimization process. Once the prompt is honed to an optimized state it may then be input to the blackbox LLM server 104 via API calls.

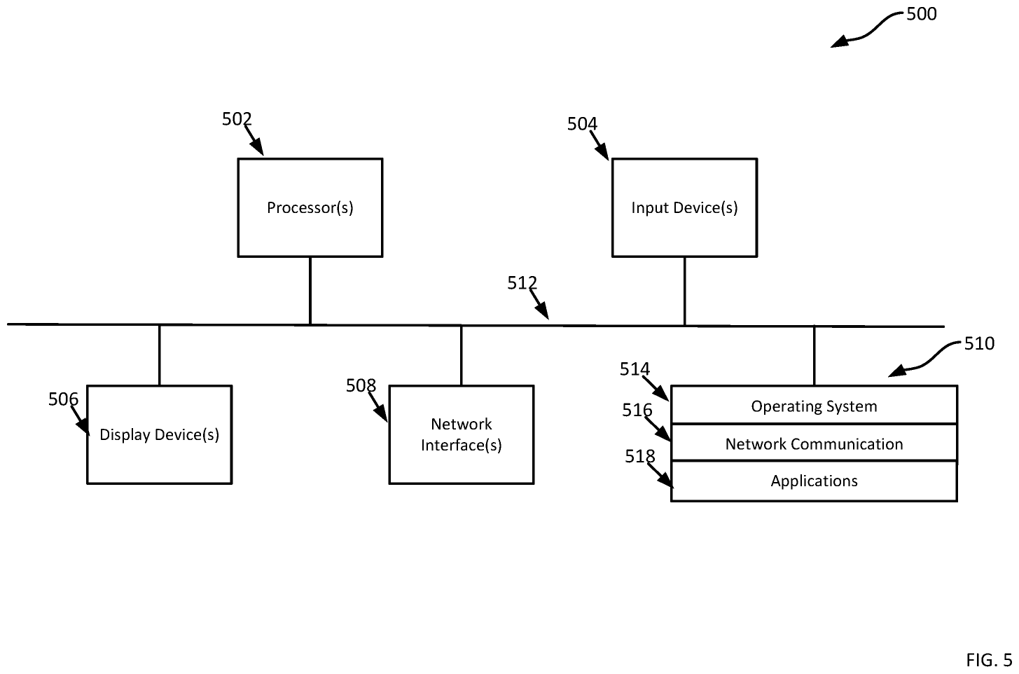

Referring now to FIG. 5, a block diagram of a computing system 500 is depicted. In some aspects, the computing system 500 may include processing units 502, input peripherals 504, an output display 506, and a networking module 508, are interconnected via a communication bus 512. The processing units 502 may serve as the central hub for computational tasks, while the input peripherals 504 may allow for user interaction, and the output display 506 may provide visual output. The networking module 508 may facilitate network connectivity, adhering to network protocols 516 managed by the system software 514.

In some cases, the computing system 500 may also include software components 510, which are interfaced with the communication bus 512. These software components 510 may include system software 514, network protocols 516, and application software 518. The system software 514 may oversee the operation of the application software 518 and manage the network protocols 516.

In some aspects, the hardware in the computing system 500 may be included in the devices shown in FIG. 1. For instance, the user device 102, the blackbox LLM server 104, the invertible embedding model server 106, and the prompt optimizer server 108 may include similar hardware components as depicted in the computing system 500. This may allow these devices to perform a variety of computational tasks, such as encoding and decoding text prompts, optimizing soft prompts, and evaluating the performance of instruction prompts.

In some cases, the processing units 502 may include one or more processors, such as central processing units (CPUs), graphics processing units (GPUs), or other types of processing units. The input peripherals 504 may include a variety of input devices, such as keyboards, mice, touchscreens, or other types of input devices. The output display 506 may include a monitor, a projector, or other types of display devices. The networking module 508 may include a network interface card (NIC), a wireless network adapter, or other types of networking devices.

In some aspects, the system software 514 may include an operating system, device drivers, or other types of system software. The network protocols 516 may include TCP/IP, HTTP, FTP, or other types of network protocols. The application software 518 may include a variety of applications, such as web browsers, word processors, spreadsheet applications, or other types of application software.

While the computing system 500 has been described with reference to specific components and configurations, it is to be understood that the computing system could be implemented with different components or configurations without departing from the scope of the system. For instance, the computing system could include additional or different types of processing units, input peripherals, output displays, networking modules, or software components. Furthermore, the computing system could be implemented in a variety of devices, such as desktop computers, laptop computers, tablets, smartphones, servers, or other types of computing devices.

The procedure presented herein addresses a distinct technical problem within the realm of blackbox Large Language Models (LLMs)—the optimization of instruction prompts to enhance LLM performance. This procedure is a concrete technical solution rooted in the computer domain of LLM processing.

The procedure employs a series of computational transformations, including encoding, dimensionality reduction, optimization, and decoding. The encoding process involves converting the discrete text prompt into a high-dimensional embedding space. This is achieved using a text embedding model, which translates the human-readable text into a machine-interpretable format. The high-dimensional embedding space captures the semantic and syntactic features of the text prompt, providing a rich representation that can be manipulated computationally. The dimensionality reduction process involves transforming the high-dimensional soft text prompt into a lower-dimensional embedding space. This is achieved using a dimension reduction module, which applies mathematical techniques to reduce the number of dimensions while preserving the salient features of the data. The lower-dimensional embedding space is more manageable for optimization, reducing computational complexity and focusing on the core features that are more relevant for the performance of the LLM. The optimization process involves refining the lower-dimensional soft text prompt to improve the performance of the LLM. This is achieved using an optimization module, which employs gradient-free optimization techniques to iteratively adjust the soft prompt based on performance feedback. The optimization process is a delicate balance of precision and efficiency, aiming to maximize the LLM's performance in both zero-shot and few-shot scenarios. The decoding process involves converting the optimized lower-dimensional soft text prompt back into a discrete text instruction. This is achieved using an invertible embedding model, which applies a reversible transformation to map the optimized soft prompt back to a corresponding discrete text instruction. The decoded text instruction can then be used as input to blackbox LLMs via API calls, potentially improving the performance of the LLM in the given task. In other words, the optimization of prompts is a practical application that manipulates high-dimensional data, translating it into optimized instructions that LLMs can process more effectively. This results in a tangible improvement in the LLM's ability to perform tasks within the NLP domain, demonstrating the procedure's practical application and its grounding in technological processes. This procedure not just enhances the performance of LLMs but also contributes to the broader field of NLP by providing a robust and efficient method for instruction optimization.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed:

1. A system for optimizing instructions for Large Language Models (LLMs), comprising:
a text embedding model configured to receive a discrete text prompt from a user device, and encode the discrete text prompt into a high-dimensional embedding space, creating a high-dimensional soft text prompt represented as a high-dimensional machine-interpretable vector;
a dimension reduction module configured to transform the high-dimensional soft text prompt to a lower-dimensional embedding space, creating a lower-dimensional soft text prompt represented as a low-dimensional machine-interpretable vector;
an optimization module configured to optimize the lower-dimensional soft text prompt by optimizing the low-dimensional machine-interpretable vector; and
an invertible embedding model configured to decode the optimized lower-dimensional soft text prompt into an output text prompt by converting the optimized low-dimensional machine-interpretable vector to the output text prompt which is configured to be input to a blackbox LLM via API calls.

2. The system of claim 1, wherein the text embedding model is configured to encode the discrete text prompt into the high-dimensional embedding space using a pre-trained language model.

3. The system of claim 1, wherein the dimension reduction module is configured to transform the high-dimensional soft text prompt into the lower-dimensional embedding space using uniform projection.

4. The system of claim 1, wherein the optimization module is a Bayesian Optimization (BO) module, configured to optimize the lower-dimensional soft text prompt using a gradient-free method, considering each soft prompt and a corresponding zero-shot performance as an input-output pair of an optimization objective.

5. The system of claim 1, wherein the invertible embedding model is a pre-trained invertible language model, configured to decode the optimized lower-dimensional soft text prompt back into a discrete text instruction, which can be used as input to the blackbox LLM.

6. The system of claim 1, further comprising:
a performance evaluation module configured to evaluate the performance of the soft text prompt using predefined testing data, including ground truth.

7. The system of claim 6, wherein the performance evaluation module is configured to calculate performance metrics given the soft text prompt, with the metrics used to evaluate the performance of the optimized instruction prompt.

8. The system of claim 7, wherein the performance metrics include at least one of an F1 score or an Area Under Receiver Operating Characteristic Curve (AUROC).

9. The system of claim 1, wherein the optimization module is configured to optimize the lower-dimensional soft prompt using a mix of Large Language Model (LLM) initialization and human handy-craft initialization to provide a diverse set of initial soft prompts for the optimization.

10. The system of claim 1, wherein the system is configured to optimize instructions for the LLMs in Natural Language Processing (NLP) tasks, thereby improving performance of the blackbox LLM in both zero-shot and few-shot scenarios.

11. A method of optimizing instructions for Large Language Models (LLMs), comprising:
receiving a discrete text prompt from a user device;
encoding, by a text embedding model, the discrete text prompt into a high-dimensional embedding space, creating a high-dimensional soft text prompt represented as a high-dimensional machine-interpretable vector;
transforming, by a dimension reduction module, the high-dimensional soft text prompt to a lower-dimensional embedding space, creating a lower-dimensional soft text prompt represented as a low-dimensional machine-interpretable vector;
optimizing, by an optimization module, the lower-dimensional soft text prompt; and
decoding, by an invertible embedding model, the optimized lower-dimensional soft text prompt into an output text prompt by converting the optimized low-dimensional machine-interpretable vector to the output text prompt which is configured to be input to blackbox LLM via API calls.

12. The method of claim 11, further comprising:
encoding, by the text embedding model, the discrete text prompt into the high-dimensional embedding space using a pre-trained language model.

13. The method of claim 11, further comprising:
transforming, by the dimension reduction module, the high-dimensional soft text prompt into the lower-dimensional embedding space using uniform projection.

14. The method of claim 11, further comprising:
optimizing, by the optimization module according to Bayesian Optimization (BO), the lower-dimensional soft text prompt using a gradient-free method, considering each soft prompt and corresponding zero-shot performance as an input-output pair of an optimization objective.

15. The method of claim 11, further comprising:
decoding, by the invertible embedding model, using a pre-trained invertible language model, the optimized lower-dimensional soft text prompt back into a discrete text instruction, which can be used as input to blackbox LLM via API calls.

16. The method of claim 11, further comprising:
performing, by a performance evaluation model, performance evaluation to evaluate the performance of the output text prompt using predefined testing data, including ground truth.

17. The method of claim 16, further comprising:
calculate, by a performance evaluation module, performance metrics as the output given the soft text prompt, with the performance metrics used to evaluate the performance of the optimized instruction prompt.

18. The method of claim 17, further comprising:
utilizing, by a performance evaluation model, at least one of an F1 score or an Area Under Receiver Operating Characteristic Curve (AUROC) as the performance metrics.

19. The method of claim 11, further comprising:
optimizing, by the optimization module, the lower-dimensional soft prompt using a mix of Large Language Model (LLM) initialization and human handy-craft initialization to provide a diverse set of initial soft prompts for the optimization.

20. The method of claim 11, further comprising:
optimizing, by the optimization module, instructions for the LLMs in Natural Language Processing (NLP) tasks, thereby improving the performance of the blackbox LLM in both zero-shot and few-shot scenarios.
